(19) United States
(12) Patent Application Publication
(10) Pub. No.: US 2005/0193379 A1
(43) Pub. Date: Sep. 1, 2005

(54) Program / method for converting spreadsheet models to callable, compiled routines

(76) Inventor: Richard Tanenbaum, New York, NY (US)

Correspondence Address: MORGAN LEWIS & BOCKIUS LLP, 1111 PENNSYLVANIA AVENUE NW, WASHINGTON, DC, 20004, US

(21) Appl. No.: 11/044,601

(22) Filed: Jan. 26, 2005

Related U.S. Application Data
(60) Provisional application No. 60/539,377, filed on Jan. 26, 2004.

(51) Int. Cl. G06F 9/45

(52) U.S. Cl. 717/140; 717/104; 717/106

(57) ABSTRACT

A computer program and a method for operating it to convert spreadsheet models into callable, compiled routines. The models are first converted into program code in a language such as C. Then the program code is compiled into computer object code.

### CROSS REFERENCE TO RELATED APPLICATIONS

This application claims priority of U.S. Provisional Application No. 60/539,377 filed on Jan. 26, 2004 which is incorporated herein by reference.

### FIELD OF INVENTION

The invention concerns a computer program and a method of operating such program for the conversion of spreadsheet models to callable routines.

### BACKGROUND OF THE INVENTION

Spreadsheets are interactive environments which many people use to model processes. They are extremely popular because the user can enter numbers, text and formulas into any cell and the formulas can be functions of other cells. This allows for the controlled and incremental building of a complex model, which can be easily debugged because the formulas and resultant values are easily seen.

Unlike traditional programming languages, spreadsheet modelers don't need to concern themselves with ordering all the operations to be performed. Rather, they only need to tell the spreadsheet, implicitly, for each cell, which cells that cell depends on. In contrast, programmers in languages like C need to explicitly specify a precise order of operations for the entire program.

Spreadsheets come with a built in set of functions besides simple arithmetic operators, and also allow the user to add in other functions that they have either built in high level languages such as C, or purchased from vendors (who have built those functions).

One drawback of spreadsheets is that they can only be accessed inside the interactive spreadsheet environment. It would be highly useful to make the model inside a spreadsheet available to programmers of larger systems using traditional languages.

Another drawback is that for the spreadsheet environment to be interactive, each formula must be interpreted, which makes calculations much slower than compiled code. The difference can be several hundred fold.

Spreadsheets also pose an enormous operational risk for the companies that rely on them. IT departments are highly concerned that users will pass spreadsheets around, and the recipients will make changes to the model that will make them incorrect. Giving users access only to compiled routines eliminates this problem.

### SUMMARY OF THE INVENTION

The current invention allows spreadsheet models to be converted to callable, compiled routines. This allows the models to be accessed from any language, and speeds up the spreadsheet calculations. It also opens up the world of coding and distributing models to a much wider audience, since many more people know how to use a spreadsheet than know how to program in a language like C. And the compiled models can be made available to users of other operating systems and platforms (so for example Windows spreadsheets like Excel can be converted to libraries callable on Unix).

The compiled routines can themselves also be turned into spreadsheet addins (which is done by the current invention) which will allow spreadsheet users to continue to use spreadsheets to create “super models” that build upon compiled models created by the invention.

The process of converting the spreadsheet to compiled code that can be called from another language has two main steps: the first converts the spreadsheet to a language like C, and the second step compiles the program code into computer object code using a compiler for the language of the program code. The second step is performed using already available tools, while the first step require many sub-steps that will be described here.

In addition, one must first create a library of functions which emulate every function built into the spreadsheet. This includes financial, math and trig, date and time, text, statistical, database, lookup and reference, and information functions. This library must have versions of each function which can take all the data types accepted by the spreadsheet functions. This is facilitated by creating a data type which can store numbers and text.

A library must also be created to support type converter functions, such as tonumber( ) and tostring( ). These function calls will be inserted into function calls in spreadsheet cells to allow for the same inherent type conversions automatically done by the spreadsheet.

The invention, is preferably implemented in a computer program that converts the spreadsheet models to program code and then compiles the program code to provide a callable function library that is callable from other programs or even other spreadsheets.

### BRIEF DESCRIPTION OF THE DRAWINGS

These and other objects, features and advantages of the invention will be more readily apparent from the following Detailed Description and accompanying flow charts wherein:

FIGS. 1A-1E are a flowchart depicting a preferred embodiment of the invention;

FIGS. 2A-2E are a flowchart depicting further details of a first step of the flowchart of FIGS. 1A-1E;

FIGS. 3A-3C are a flowchart depicting further details of a second step of the invention;

FIG. 4 is a flowchart depicting further detail of a third step of the invention;

FIGS. 5A-5C are a flowchart depicting further details of a fourth step of the invention;

FIGS. 6A and 6B are a flowchart depicting further details of a fifth step of the invention;

FIGS. 7A and 7B are a flowchart depicting further details of a first step of the flowchart of FIGS. 2A-2E;

FIG. 8 is a flowchart depicting further detail of a second step of the invention;

FIGS. 9A and 9B are a flowchart depicting further details of a third step of the invention;

FIGS. 10A-10C are a flowchart depicting further details of a fourth step of the invention.

### DETAILED DESCRIPTION

As indicated above, one must first create a library of functions which emulate every function built into the spreadsheet. This includes financial, math and trig, date and time, text, statistical, database, lookup and reference, and information functions. This library must have versions of each function which can take all the data types accepted by the spreadsheet functions. This is facilitated by creating a data type which can store numbers and text. In C, this is done with a union.

A library must also be created to support type converter functions, such as tonumber( ) and tostring( ). These function calls will be inserted into function calls in spreadsheet cells to allow for the same inherent type conversions automatically done by the spreadsheet. For example, spreadsheet cell A1 containing the formula =“123”+4 will display the result 127. Thus, the line of C code that will be generated must be of the form A1=tonumber(“123”)+4.

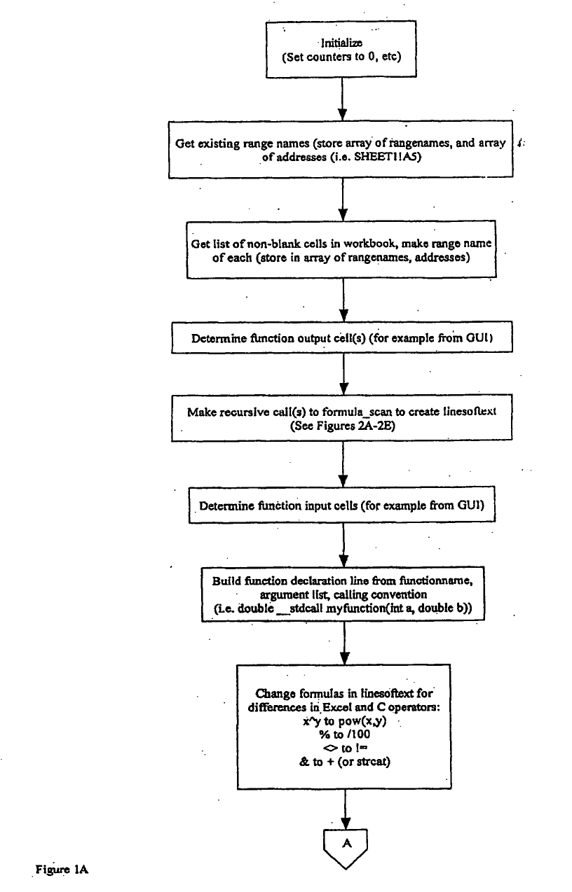

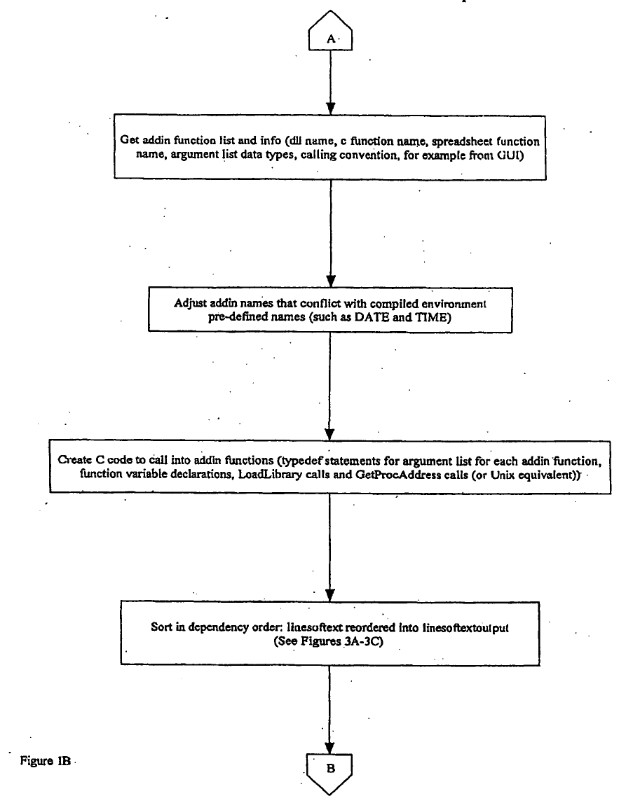

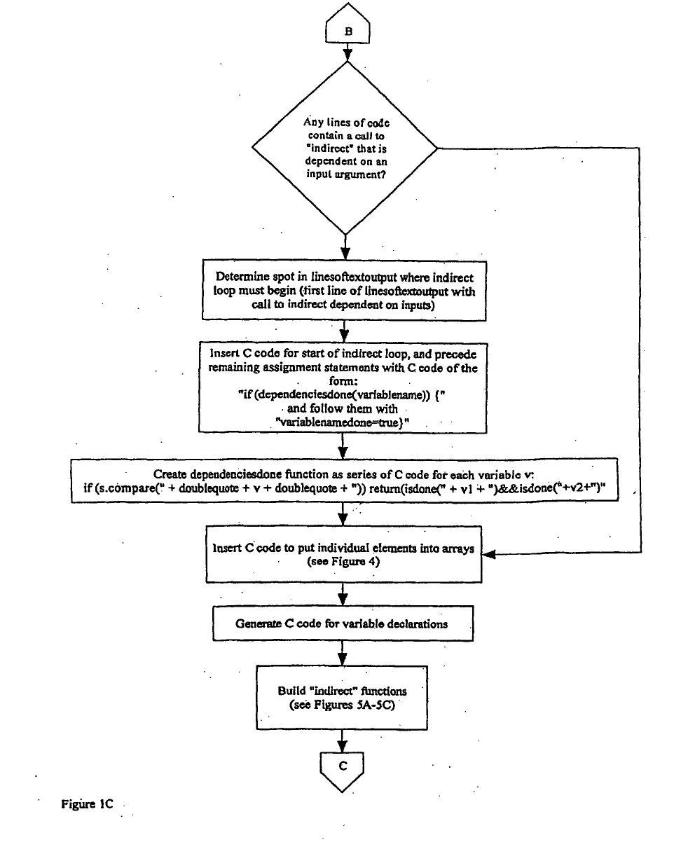

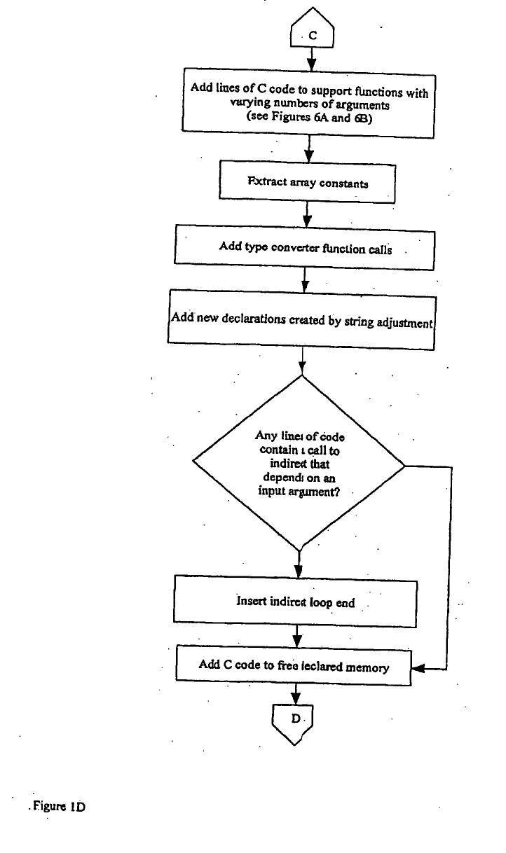

With these libraries in place, a preferred embodiment of the method for converting spreadsheet model to program code comprises the steps of FIGS. 1-10 and the accompanying discussion:

The overall operation of the invention is described in the following pseudocode and in FIGS. 1A-1E. References in this pseudocode to other figures provide further details of the step to which the reference is made.

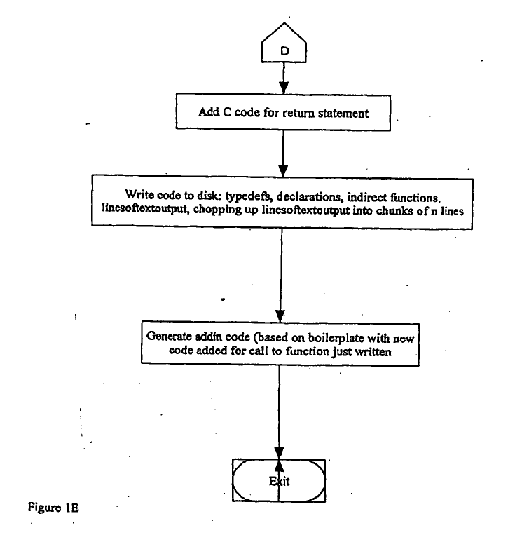

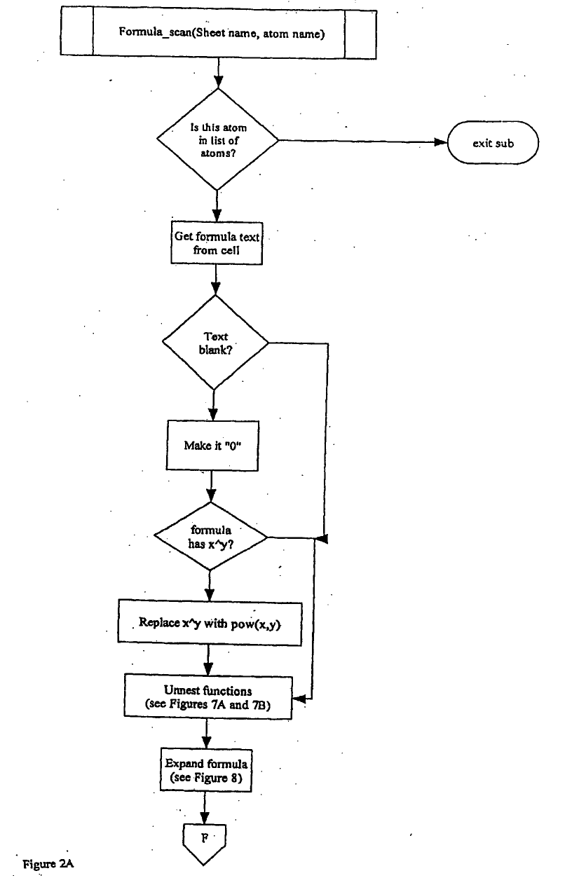

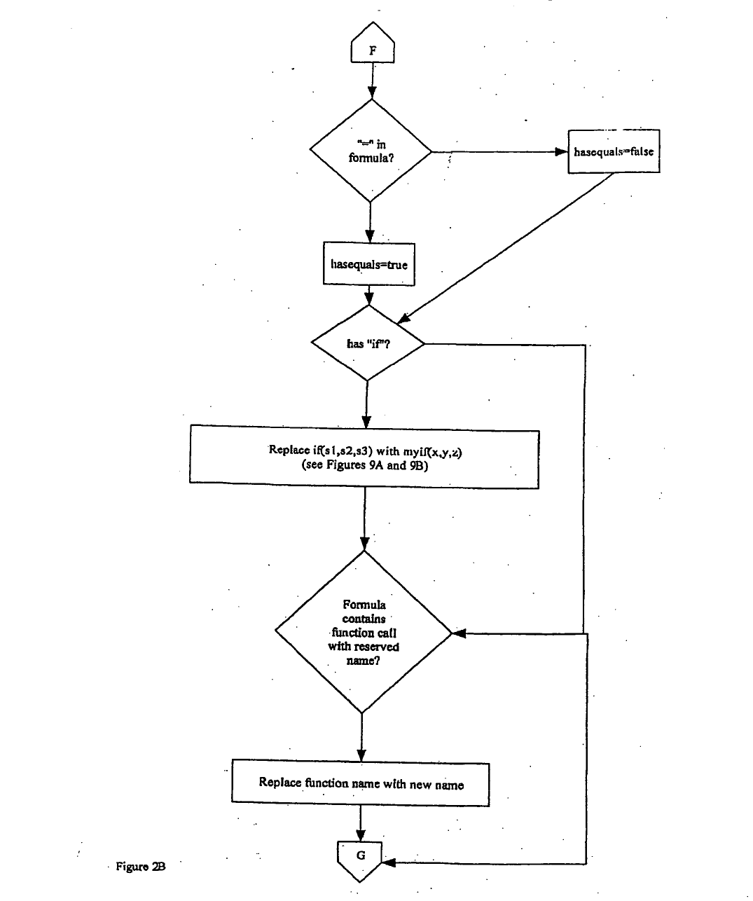

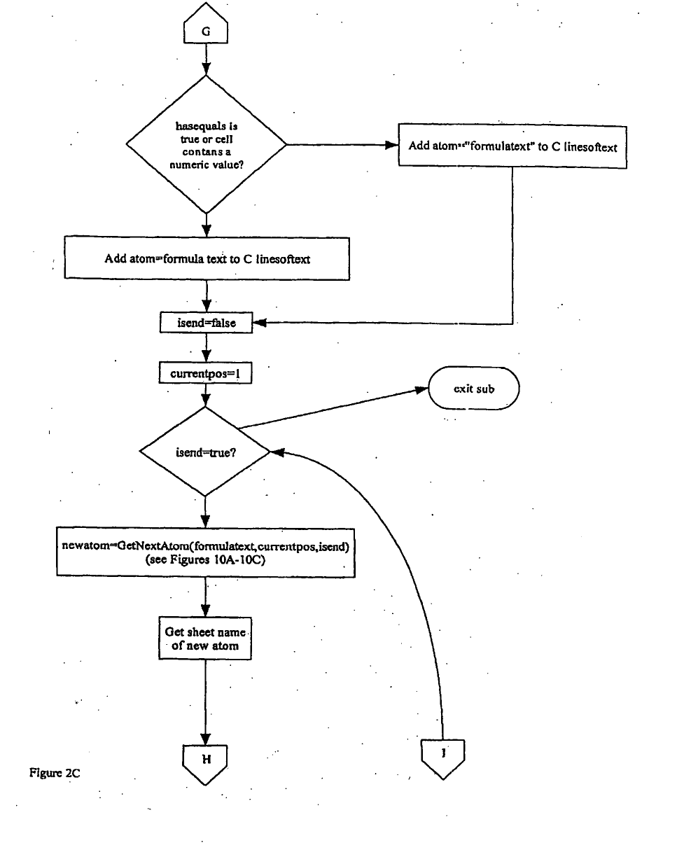

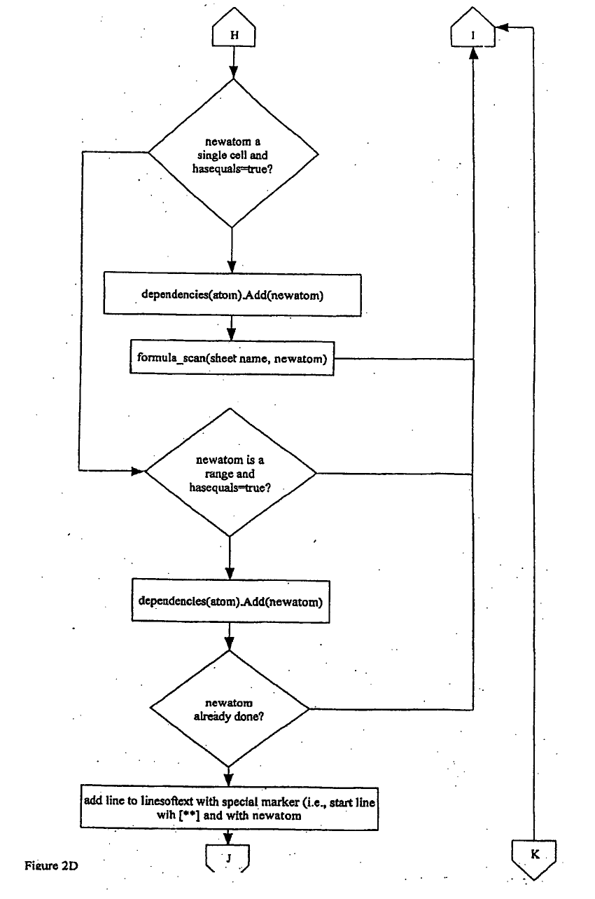

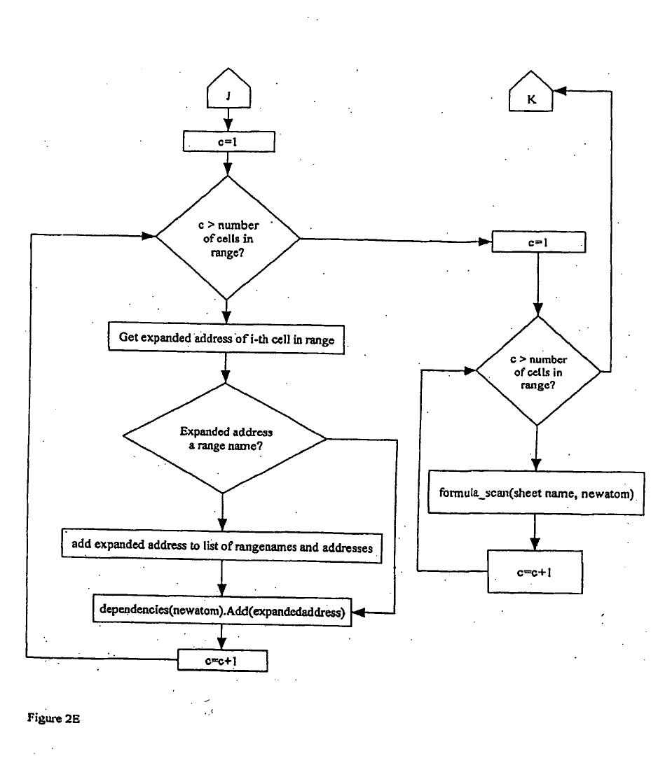

initialize
get existing range names
get list of all non-blank cells in workbook
determine function output cell(s)
make recursive call(s) to create linesoftext [see FIGS. 2A-2E]
determine function input cell(s)
build function prototype line
change formulas in linesoftext

x\hat{ }y to pow(x,y)
% to /100
<> to !=
& to + or strcat( )

determine addin function list and info (library name, c function
name, spreadsheet function
name, argument list, calling conventon
adjust reserved names (date, time, etc.) tobe string_reserved name
create code lines required to call into those functions

typedef
function variable declaration
loadlibrary
getprocaddress

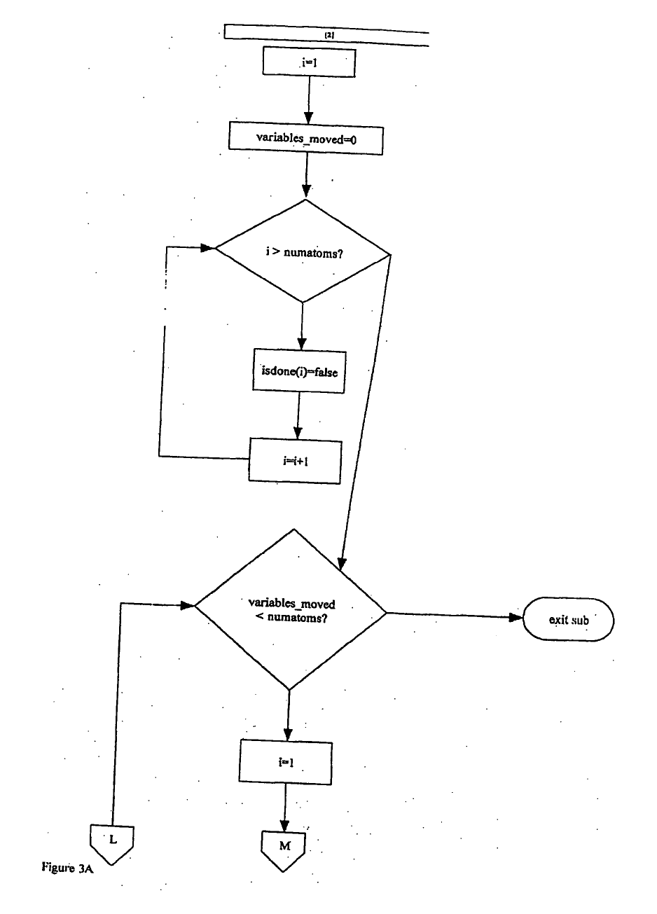

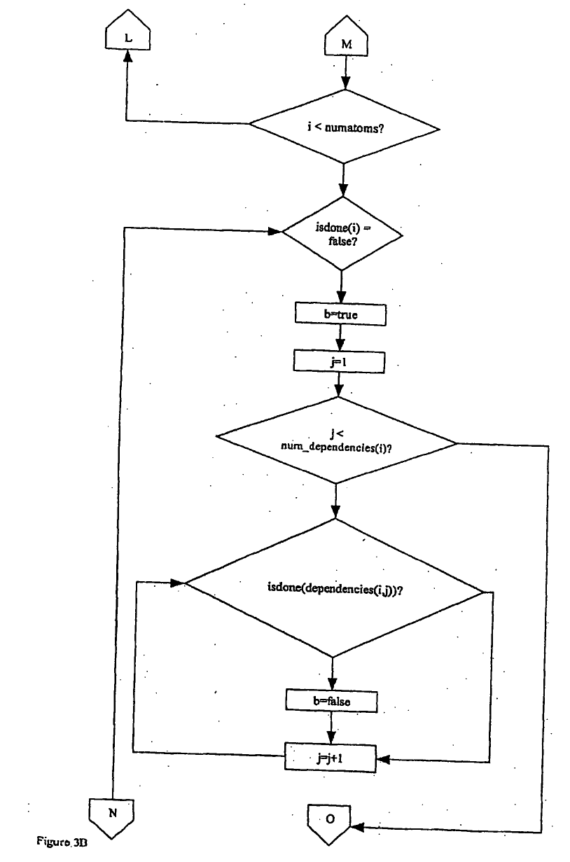

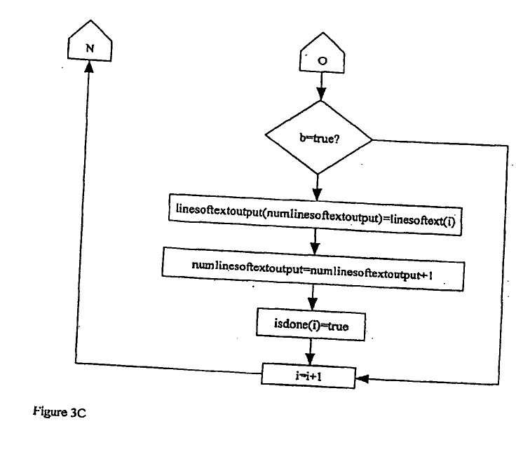

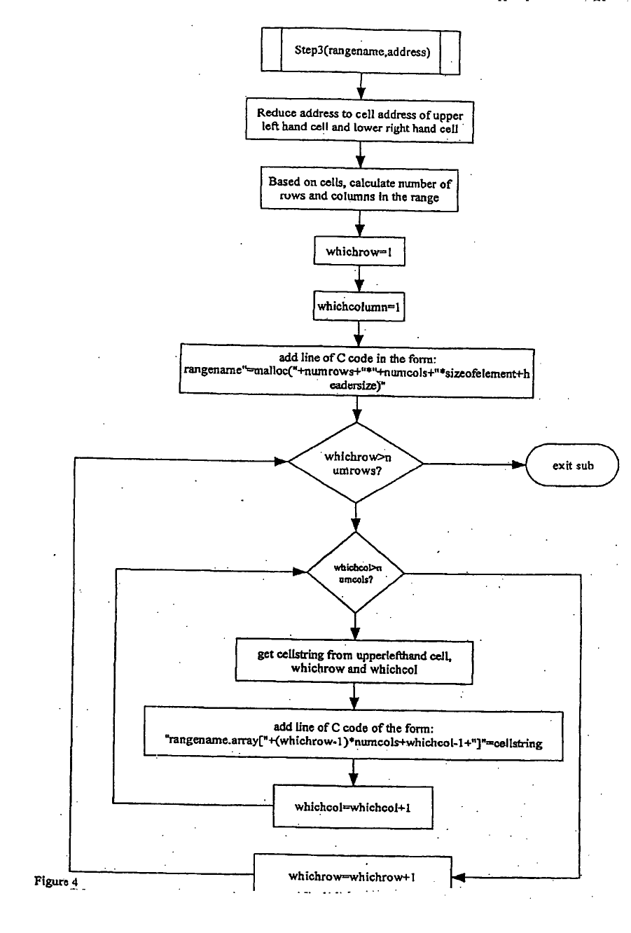

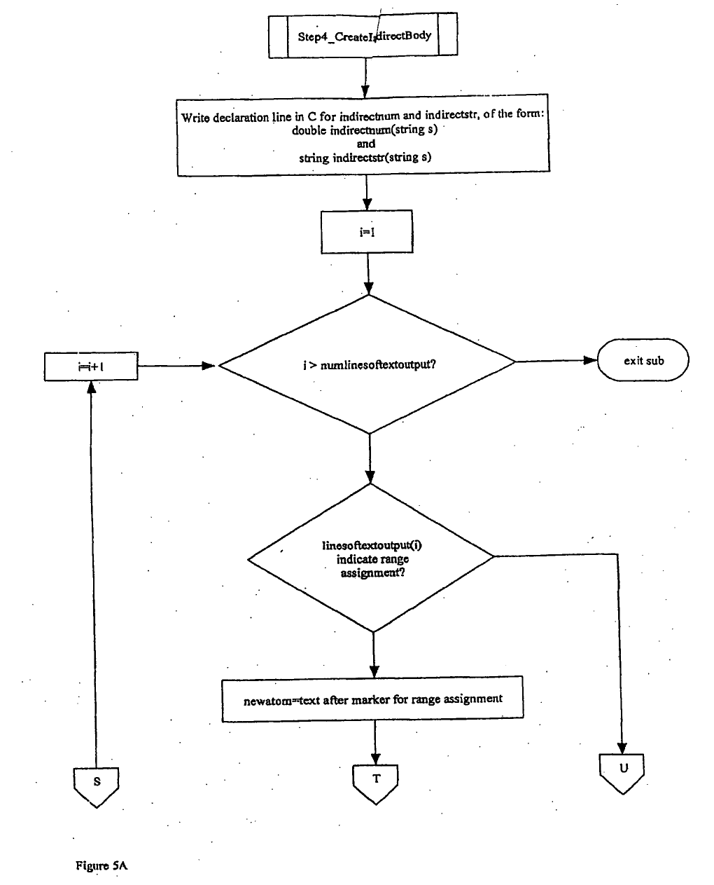

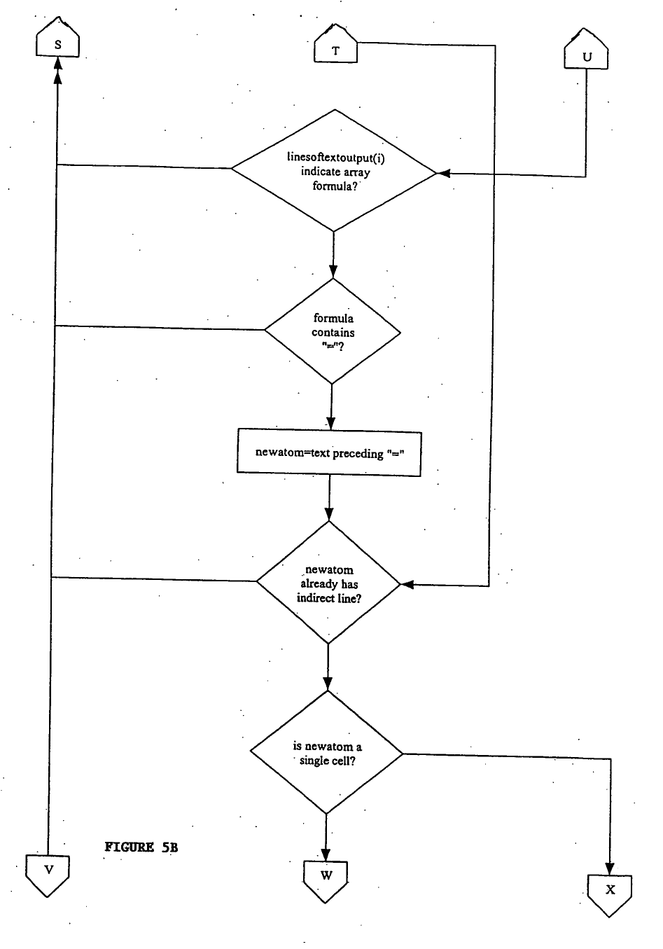

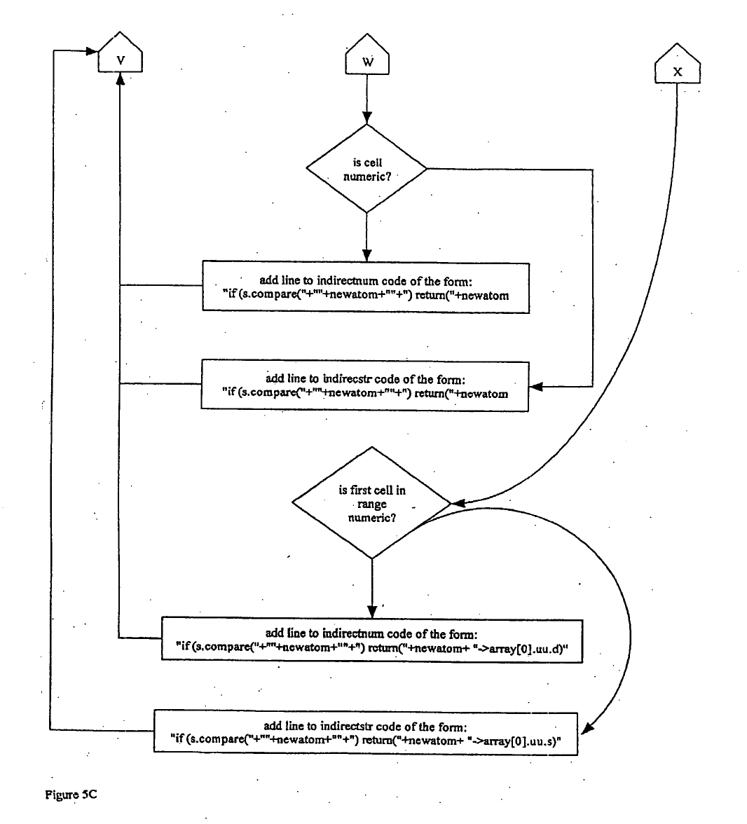

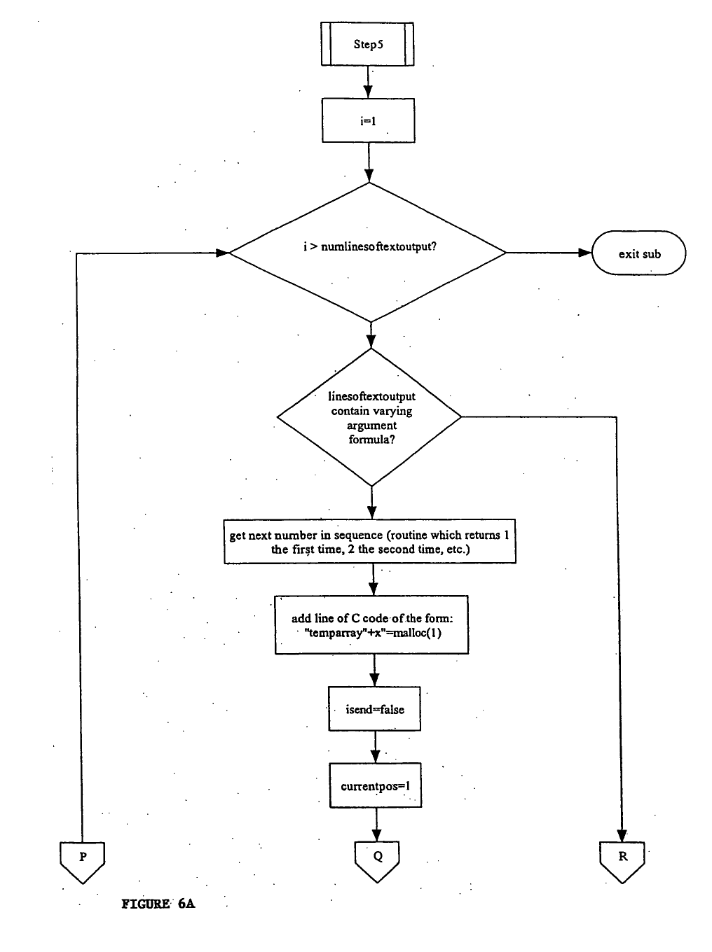

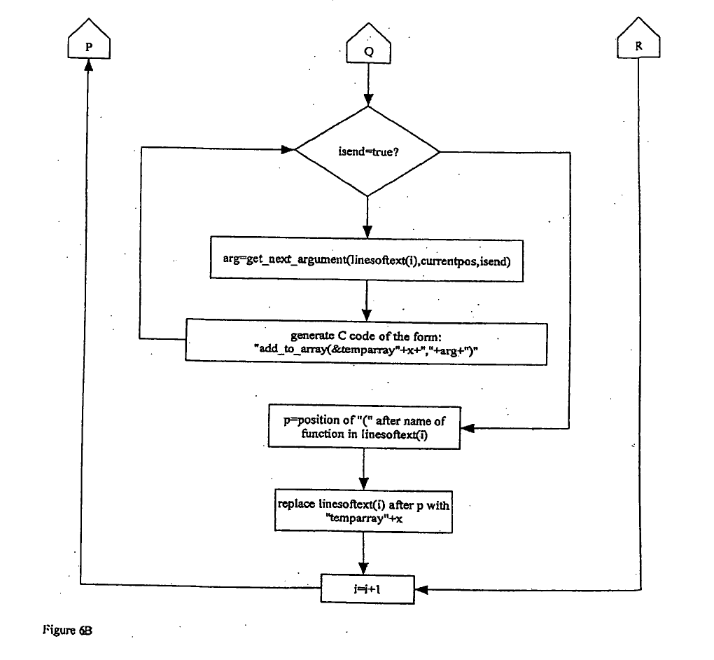

sort in dependency order [see FIGS. 3A-3C]
determine spot where indirect loop must begin
insert indirect loop start
create code to insert elements into arrays [see FIG. 4]
build declarations
build indirect functions [see FIGS. 5A-5C]
add lines of code to support varying numbers of arguments to
functions [see FIGS. 6A and 6B]
extract array constants
add type converter function calls (including string adjustment)
add new declarations created by string adjustment
insert indirect loop end
add code to free declared memory
add return statement
write code to disk, inserting chopped up functions if necessary
write addin code
compile and link first program
compile and link second program
clean up spreadsheet and disk

FIGS. 2A-2E

This step consists of a subroutine which is given a cell reference, and creates a line of code that is:
cell_reference=cell_formula
   and then, for any cell references in cell_formula, recursively calls into itself to generate C code for the new cell references.

Some extra steps are needed, though, to work with a clean formula. The entire routine is:

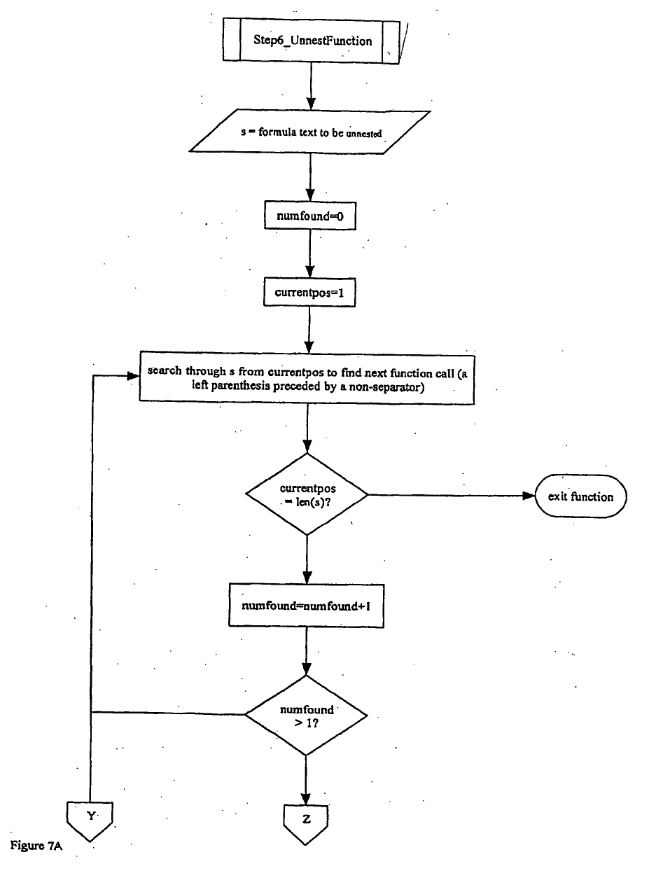

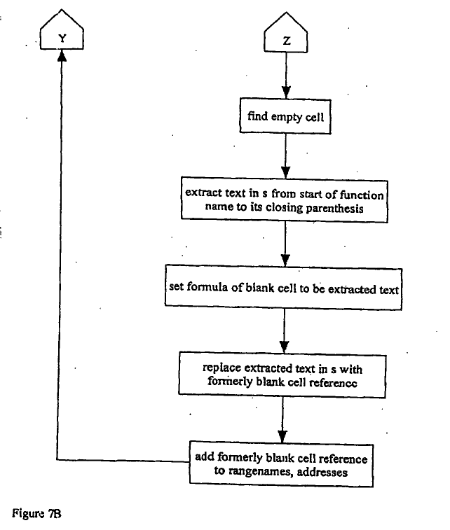

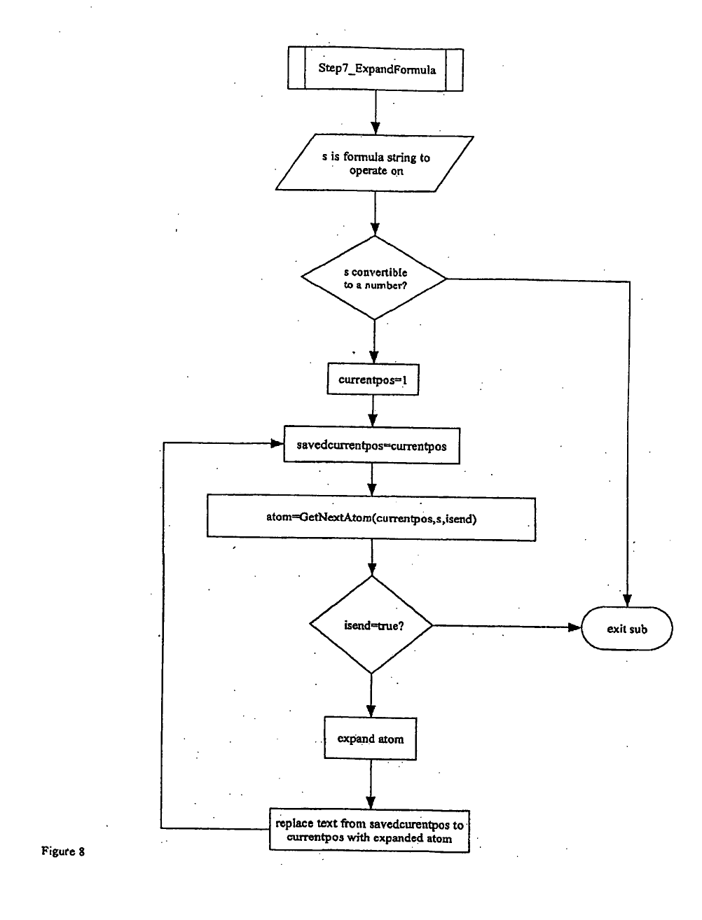

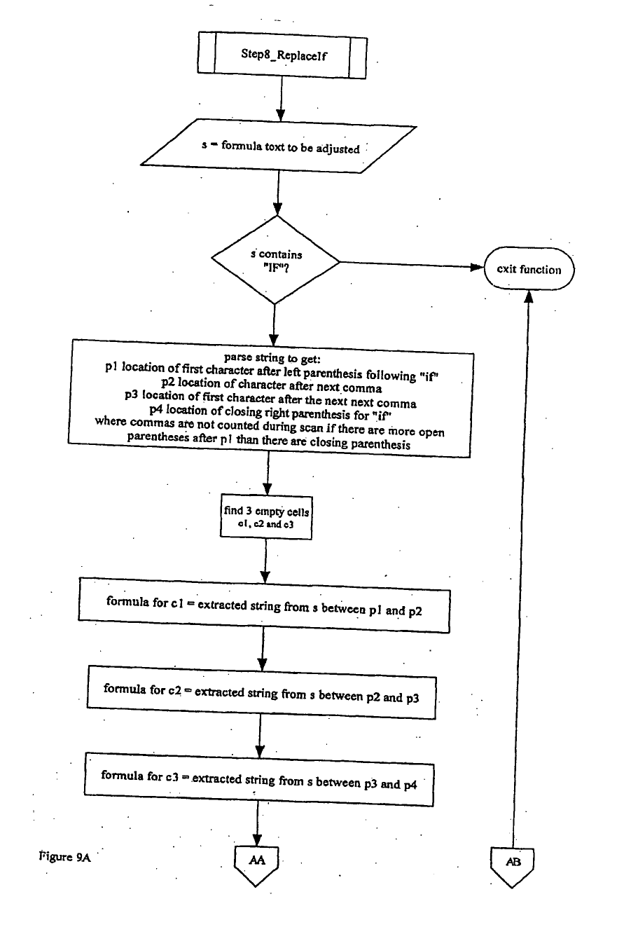

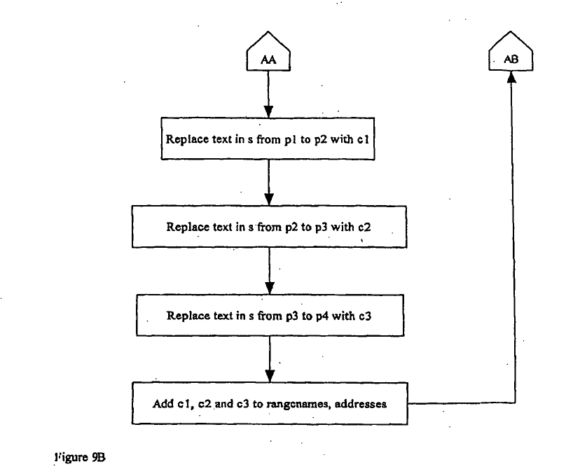

check if this cell_reference has already been done, if so, exit routine
get formula_text from cell
if blank, make it “0”
replace x\hat{ }y with pow(x,y)
unnest functions [see FIGS. 7A and 7B]
expand formula [see FIG. 8]
note if “=” in formula
replace “IF” statements [see FIGS. 9A and 9B]
check for reserved word in cell_reference, and change if necessary
if removedequals or cell contains a number then

add to lines of text created

else add to lines of text created with double quotes around the
formula_text
while not done with formula_text (scan through it from left to right)

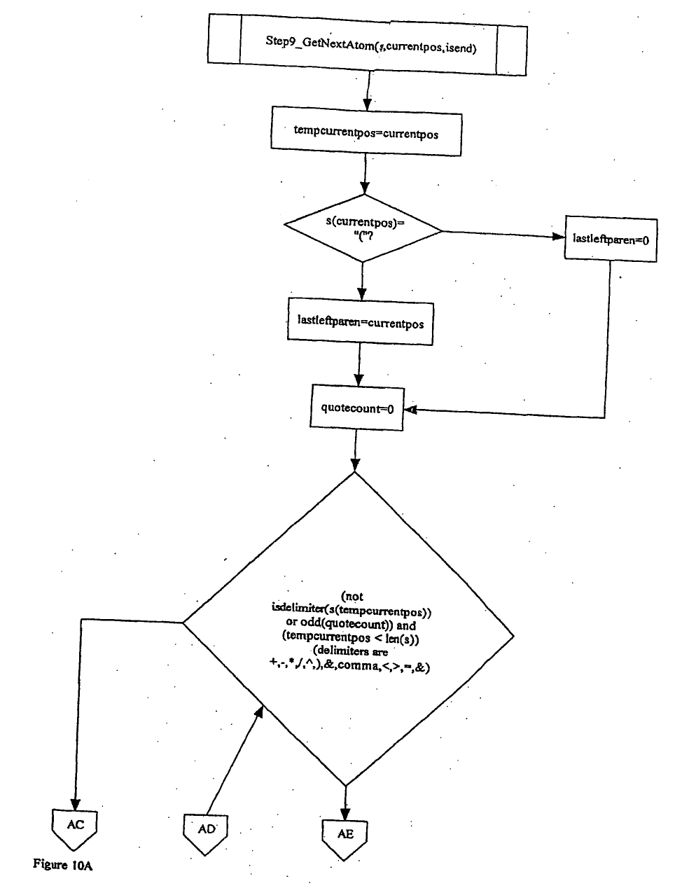

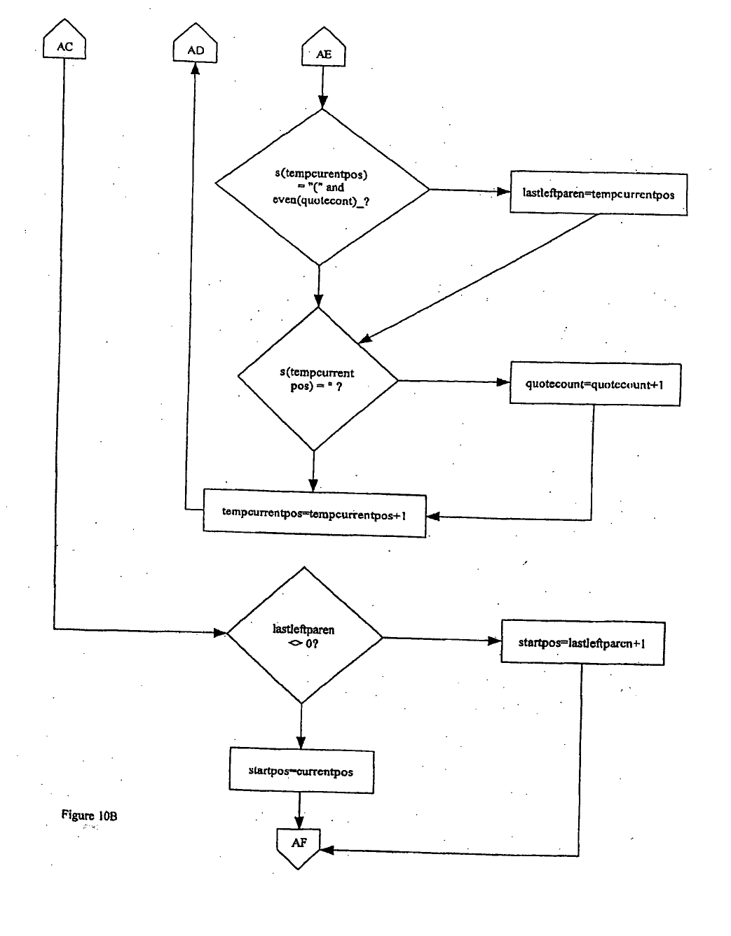

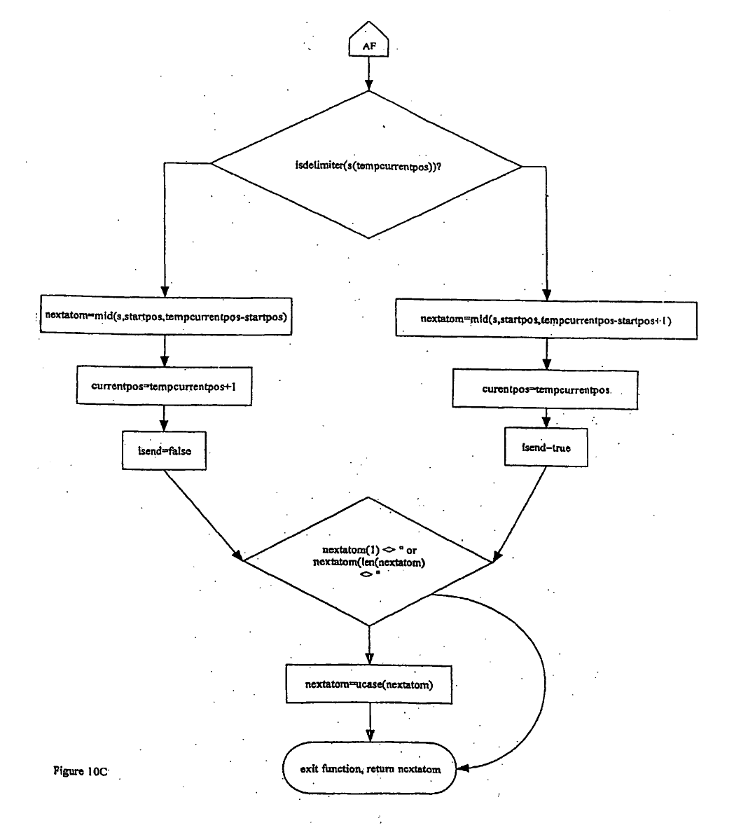

newatom=get next atom [see FIGS. 10A-10C]
get sheet name of newatom
if newatom is a cell and removedequals then

update dependencies(cell_reference,newatom)
recursive call with sheet name and newatom

else if newatom is a range name and removedequals then

update dependencies(cell_reference,newatom)
if newatom has already been done, then

goto skiprange

endif
add to lines of text created, with a special marker to
indicate later expansion
for each cell in range

get its expanded address
if expanded address is not already a range name then

make expanded address a range name

endif
update dependencies(newatom,expandedaddress)

next cell in range
for each cell in range

make recursive call

next cell in range

skiprange:

endif

endif

wend

FIGS. 3A-3C

One way to sort in dependency order is to take the lines of code that have been obtained in the method of FIGS. 2A-2E and move them to a new set of lines of code on the fly. A list of all the variables seen to this point is kept, as well as, for each of these variables, a list of which other variables that varible depends on. Another list can be kept of whether that variable's assignment statement has been moved to the sorted list of lines of code.

For example, there can be a one dimensional list called variables_seen, an one dimensional array called num_dependencies, and a two dimensional array called dependencies. Variables_seen would contain strings such as A1, A2, myrangename, etc. If A1 contained the formula =B1*5+C2 and was the third variable seen, then num_dependencies(3) would be 2, and dependencies(3,1) would be “B1” and dependencies(3,2) would be “C2”.

The pseudocode is:

for i = 1 to numvariables

isdone(i)=false

while variables_moved < numvariables

for i = 1 to numvariables

if not isdone(i) then

b=true
for j = 1 to num_dependencies(i)

if not isdone(dependencies(i,j) then

b=false

endif

next j
if b then

copy_to_output(i)
isdone(i)=true

endif

endif

next i

wend

FIG. 4

Spreadsheet range names can be for single cells, or ranges with multiple cells. If a cell contains a formula referencing a1:b10, it will have been earlier converted to SHEETNAME_A1_B10, and this will be the reference in the formula. At this time, it is necessary to insert code which allocates memory for an array that will represent this range, and set each element of the array appropriately:
SHEETNAME_A1_B10=(FP)malloc(10*2*sizeof(FP)+fpheadersize)
SHEETNAME_A1_B10.array[0]=SHEETNAME_A1
SHEETNAME_A1_B10.array[1]=SHEETNAME_B1
SHEETNAME_A1_B10.array[2]=SHEETNAME_A2
SHEETNAME_A1_B10.array[19]=SHEETNAME_B10

The code generator will know the name of the range variable, as well as the address of the range it references. It is thus able to know the size to pass to malloc, and in a loop over all the rows and columns in the range, can create the lines of text shown above.

FIGS. 5A-5C

One built-in spreadsheet function is INDIRECT. It takes a cell reference, and if that referenced cell contains a reference to another cell, the function returns the value of the second referenced cell. So if A1 contains “c2”, C2 contains 100, amd B1 contains =INDIRECT(A1), then B1 would have the value 100. One way to handle this is to create the INDIRECT emulation inside the generated C code, instead of the pre-built library of spreadsheet emulation functions. There would be two INDIRECT functions, one returning text and the other returning a string. Which one would be called would depend on the data type of the cell that contains the call to INDIRECT.

The generated code for INDIRECT consists of a prototype which accepts a string, and returns either a string or number, depending on which of the two generated functions it is. The body of the routines consists of a series of if statements, one for each variable in the program. The if statement is of the form:
if stringarg=“variable_i” then return(variable_i).
   This effectively allows one to pass in the name of a variable, and get back the value of that variable.
   FIGS. 6A-6B

Some spreadsheet functions take varying numbers of arguments. For example, can have =SUM(1,2,3) or =SUM(1,2,3,4), or even =SUM(1,2,3,a1:b2) which is equivalent to =SUM(1,2,3,a1,a2,b1,b2). C does not support this, so accommodation must be made. one way to do this is to make the emulated SUM function take just a single argument, which is an array that holds the values to be summed, as well as the number of elements in the array. Then, when formula in cell A1 contains =SUM(x,y,z) this code is expanded to:
temparray1=malloc(0)
add_to_array(&temparray1,x)
add_to_array(&temparray1,y)
add_to_array(&temparray1,z)
A1=SUM(temparray1)
   In this case add_to_array expands the size of temparray1 based on the size of the variable being added, so if y is a range, space is allocated for the entire range.

Implementing this step can be done by scanning through each line of generated code and checking if there is a function call to a pre-defined list of functions which accept varying numbers of arguments (i.e., does the line of generated code contain the word “SUM”)

FIGS. 7A and 7B

Formulas will often contain multiple calls to other functions. These will sometimes include nested function calls. To facilitate the parsing and code generation process, the process uses temporary variables, or empty cells, to decompose a formula down to multiple formulas each made up of simpler parts.

A formula that contains A1=1+2+EXP(B47)*SUM(B47,EXP(B49)) will be changed to (assuming B50, B51 and B52 are currently empty):
B50=EXP(B47)
B51=EXP(B49)
B52=SUM(B47,B51)
A1=1+2+EXP(B47)*B52

The method used in this embodiment allows a cell to contain at most one function call (zero calls is impossible). This is accomplished by scanning through the formula_text, and wherever a function name is encountered by itself (i.e. SUM is not found inside a function called SUMMARY), that is not part of a text string (i.e. the formula is not “The sum is”&B51), adding one to counter that has been initialized to 0. If the counter becomes greater than 1 then:

an empty cell is found;

the text for the newly found function (from the start of its name to its closing parenthesis) is replaced with the expanded name of an empty cell;

the empty cell name and address are added to the list of variables, addresses and range names;

the formula for the newly found function is placed in the empty cell; and

the original formula scan continues to search for more function names in the formula_text.

FIG. 8

Formulas will contain numbers, text, function calls, range names, cell references. Cell references represent a problem because they will often be unqualified, which means they will not have the row and column identifier preceded by a sheet name. The spreadsheet implicitly assumes the sheet name is the same as the sheet name of the cell referencing that cell. It is thus necessary in a compiled environment to add the qualifier to cell references explicitly. The convention used in this embodiment is to create a range name for all cells, and to make the name be qualifier+“_”+cell reference. Qualifier can be sheet name, or a workbook name and then a sheet name and then the cell reference. This removes any ambiguity. At this stage a range name is created for each of these cells, and those names are used for their variable names.

So if Sheet1!A1 contains the formula =B1+2, this is changed to:
a range name is created called SHEET1_A1;
a range name is created called SHEET1_B1; and
a line of code is created that says:
SHEET1_A1=2+SHEET1+B1.
   Since spreadsheet names are not case sensitive, it is preferable to convert all names and addresses to upper case.
   FIGS. 9A and 9B

Spreadsheets allow functions of the form =IF(A52>47,12,14). This would not be a valid line of C code. In particular, the > in the first argument would force the first argument to be passed as a string, and the C code would need to contain an explicit parser which was capable of handling any general mathematical expression, including calls to external functions that have been added in by the user. This is difficult if not impossible to do.

One solution is to take each argument of the IF function, and place its text in three empty cells, and then replace the text in the IF formula with the name of the empty cells. So,
A1=IF(A52>47,12*2,A2+14)
   is replaced by
B1=A52>47
B2=12*2
B3=A2+14
A1=IF(B1,B2,B3)

which will not be a problem for the C compiler.

FIGS. 10A-10C

A formula is said to be made up of “atoms” which are the smallest units that are separated by operators. Operators consist of +,−,*,/,\hat{ },),&,comma,<,>,=,% with any text within double quotes treated as a single atom. When searching for all cell references in a formula, this can be accomplished by scanning through the formula for each atom, starting at a position, and going forward until one of the described delimiters has been reached.

As will be apparent to those skilled in the art, numerous modifications may be made in the methods described above and in the computer code used to implement such methods. While the invention has been described in the context of conversion of the spreadsheet into C program code, it will be appreciated by those skilled in the art and familiar with the foregoing description that the invention could also be practiced in converting the spreadsheet into other high level language such as Java, Visual Basic, Fortran, Pascal, and C⁺⁺. In addition, these steps can operate equally well within an environment provided by the spreadsheet (written in the spreadsheet's macro language while the spreadsheet is open) or based on the spreadsheet file itself.

1. A method of converting a spreadsheet model into a compiled routine comprising:
converting the spreadsheet model into program code in a computer language; and
compiling the program code into computer object code.

2. The method of claim 1 wherein the computer language is C.

3. The method of claim 2 wherein the program code is compiled using a C compiler.

4. The method of claim 1 wherein the computer object code is in a form that can be called from a spreadsheet.

5. The method of claim 1 wherein the computer object code is in a form that can be called from another language.

6. A computer program stored in a storage medium comprising instructions for converting a spreadsheet model into program code in a first computer language.

7. The computer program of claim 6 further comprising instructions for compiling the program code.

8. The computer program of claim 6 further comprising instructions constituting a library of functions that emulate functions built into a spreadsheet.

9. The computer program of claim 6 further comprising instructions to implement type converter functions.
